(19) United States
(12) Patent Application Publication
(10) Pub. No.: US 2021/0348418 A1
(43) Pub. Date: Nov. 11, 2021

(54) INSTALLATION KIT FOR ELECTRIC LOCK

(71) Applicant: TAIWAN FU HSING INDUSTRIAL CO., LTD., Kaohsiung City (TW)

(72) Inventor: SHIH-MIN LU, KAOHSIUNG CITY (TW)

(21) Appl. No.: 17/307,294

(22) Filed: May 4, 2021

(30) Foreign Application Priority Data
May 6, 2020 (TW) 109205455

(51) Int. Cl. E05B 9/08; E05B 9/00; E05B 47/00

(52) U.S. Cl. CPC E05B 9/08; E05B 47/0001; E05B 9/002

(57) ABSTRACT

The installation kit for an electric lock includes a second lock having a rotary part. The rotary part includes a second shaft. A sleeve is driven by the rotary part and includes a passage which forms an opening formed to one end of the sleeve. A latch bolt includes an operation portion. A first lock includes a first shaft which is engaged with the operation portion so as to lock or unlock the latch bolt. The first shaft of the first lock is engaged with the passage of the sleeve and is co-rotated with the sleeve. The opening is a straight linear-shaped opening, a rectangular-shaped opening so as to be cooperated with the first lock. The second lock can be replaced a new one and operates the first lock and the latch bolt by the rotary part of the second lock.

### BACKGROUND OF THE INVENTION

### 1. Fields of the Invention

The present invention relates to an installation kit for an electric lock, and more particularly, to an installation kit that is compatible with parts of the lock on inside or outside of the door when installing a new lock to outside of inside of the door.

### 2. Descriptions of Related Art

The conventional door lock includes a first lock which is installed to the outside of a door for example, and the users can unlock the door lock by using a correct key or by an authorized password. A second lock is installed to the inside of the door, which includes a knob so as to allow the users to lock or unlock the door lock from inside.

There are different types of the first locks on the outside of the door, and the transmit mechanism of the different first locks include different parts. Therefore, the same brand of the first lock is required when choosing parts for the second lock that is to be installed to the inside of the door, such that the first and second locks can be locked or unlocked. However, the first lock usually includes a high degree of professional technology so that most of the lock manufacturers usually specialize in design and manufacturing of the specific type of first locks, such as mechanical locks or electronic locks. Cross-field first lock component companies are relatively rare. Therefore, if the users have to replace a different lock of the door, moreover, if the users want to replace the original second lock on the inside of the door with a new electronic lock that is manufactured by a different manufacturer, it is possible that the knob of the second lock cannot be matched with the first lock assembly on the outside of the door. The entire set of the first and second locks need to be replaced, which will cause the users to spend a lot of time and money.

The present invention intends to provide an installation kit of the shaft of the first lock that allows the users to replace a second lock of different brand from the first lock.

### SUMMARY OF THE INVENTION

The present invention relates to an installation kit for an electric lock, and the installation kit comprises a first lock having a first shaft. A second lock includes a rotary part rotatably connected thereto, and the rotary part includes a second shaft. A sleeve is engaged with the rotary part and is driven by the rotary part. The sleeve includes a passage which has an opening. The opening is shaped to be matched with the first shaft which extends through the passage via the opening. A latch bolt includes an operation portion. The first shaft extends through the operation portion and is connected to the rotary part so as to rotate the operation portion to lock or unlock the latch bolt.

Preferably, the sleeve includes a first flange and a recess that is defined in one end of the sleeve. The second shaft is engaged with the recess.

Preferably, the second shaft includes at least one first surface. At least one second surface is formed to the inner periphery of the recess. When the second shaft is engaged with the recess, the at least one first surface and the at least one second surface are engaged with each other to form a non-circle shape.

Preferably, at least one protrusion extends from the inner end of the recess. The second shaft includes at least one notch with which the at least one protrusion is engaged.

Preferably, the opening is a straight linear-shaped opening, a rectangular-shaped opening, a D-shaped opening, a cross-shaped opening or a polygonal-shaped opening.

Preferably, the second lock is an electric lock.

Preferably, the first lock is an assistant lock and includes a first lock cylinder which is connected with the first shaft.

Preferably, the latch bolt includes at least one fixing hole. The second lock includes at least one fasten element. A plate includes at least one first bore that is located corresponding to the at least one fixing hole. The plate includes a second bore that is located corresponding to the sleeve. The inner diameter of the at least one first bore is larger than the outer diameter of the at least one fasten element. At least one adaptor is mounted to the at least one fasten element so that the at least one fasten element extends through the at least one first bore and is fixed to the at least one fixing hole.

Preferably, the at least one adaptor is made of resilient material and is engaged with the inner periphery of the at least one first bore.

Preferably, the at least one adaptor includes a second flange which faces the second lock. The outer diameter of the second flange is larger than the inner diameter of the at least one first bore.

Preferably, the at least one first bore is a circular bore, an elongate bore, an oval bore, a polygonal bore or any geometric shape bore.

Preferably, the second lock includes a plate. The plate includes a second bore located corresponding to the sleeve.

The present invention also provides yet another installation kit for an electric lock, and comprises a sleeve including a passage which forms an opening in the first end of the sleeve. A first flange extends radially from the second end of the sleeve. A recess is defined in the second end of the sleeve. At least one second surface is formed to the inner periphery of the recess. At least one protrusion extends from the inner end of the recess. The at least one second surface is a non-circle surface.

Preferably, the electric lock includes a knob which has a second shaft formed thereto. The second shaft includes at least one first surfaced and at least one notch. The at least one first surfaced is a non-circle surface which is engaged with the at least one second surface. The at least one protrusion of the sleeve is engaged with the at least one notch of the second shaft.

Preferably, the opening is a straight linear-shaped opening, a rectangular-shaped opening, a D-shaped opening, a cross-shaped opening or a polygonal-shaped opening.

The advantages of the present invention are that the opening formed by the passage of the sleeve can be a straight linear-shaped opening, a rectangular-shaped opening, a D-shaped opening, a cross-shaped opening or a polygonal-shaped opening so as to be compatible to first shaft of the first lock. Therefore, when the second lock is replaced, the new second lock can be cooperated with the first lock, such that the first lock and the latch bolt are able to be locked or unlocked by rotating the rotary part of the second lock.

By using the plate of the present invention, the door and the second lock are conveniently installed. The distance between the fasten element and the fixing holes of the latch bolt is adjustable. The diameter of the first bores is larger than the diameter of the fasten element, and the adaptors are made by resilient material, so that the fasten element with various sizes of the first lock can be used with the second lock.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the first lock, the second lock, and the latch bolt are installed to a door;

FIG. 2 is an exploded view of the disclosure as shown in FIG. 1;

FIG. 3 is a perspective view to show the sleeve of the present invention;

FIG. 4 is a cross sectional view to show that the first lock, the second lock, the latch bolt and the installation kit of the present invention are installed to a door, wherein the position of the sleeve is disclosed;

FIG. 5 is a cross sectional view to show that the first lock, the second lock, the latch bolt and the installation kit of the present invention are installed to a door, wherein the position of the adaptors is disclosed;

FIG. 6 shows that the opening of the passage is a straight linear-shape opening;

FIG. 7 shows that the opening of the passage is a rectangular-shaped opening;

FIG. 8 shows that the opening of the passage is a straight linear-shape opening and is tilt by 45 degrees, and

FIG. 9 shows that the opening of the passage is a D-shaped opening.

### DETAILED DESCRIPTION OF THE PREFERRED EMBODIMENT

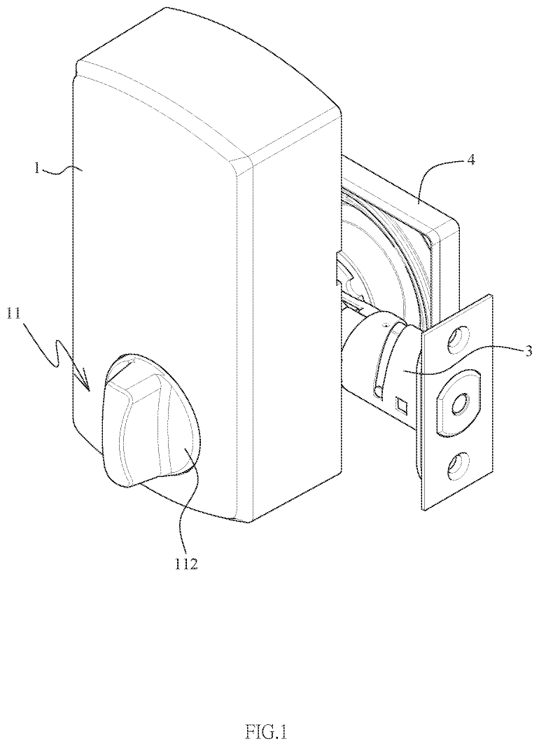

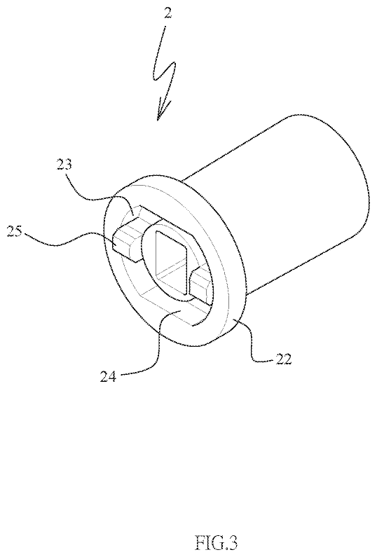

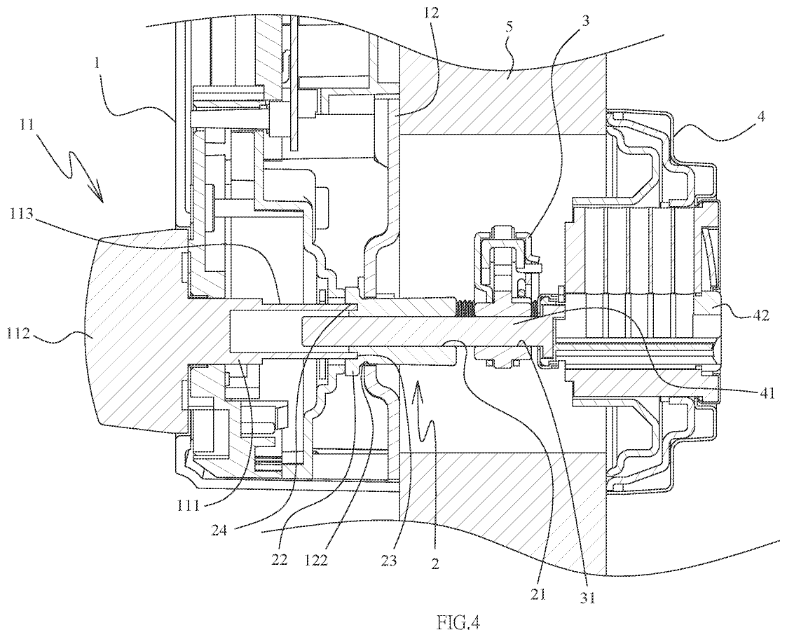

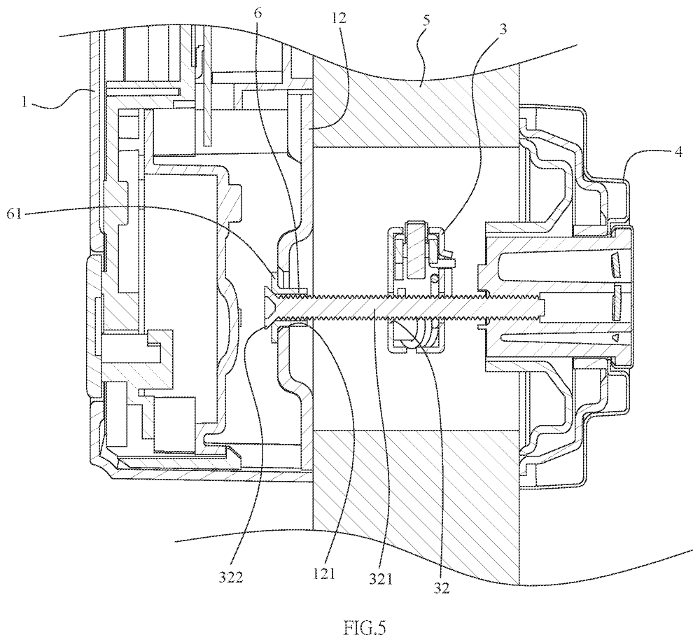

Referring to FIGS. 1 to 5, the installation kit for an electric lock of the present invention comprises a first lock 4 having a first shaft 41. A second lock 1 having a rotary part 11 rotatably connected thereto. The rotary part 11 includes a second shaft 111. A sleeve 2 is engaged with the rotary part 11 and is driven by the second shaft 111 of the rotary part 11. The sleeve 2 includes a passage 21 which forms an opening in the first end of the sleeve 2. The opening is shaped to be matched with the first shaft 41 which extends through the passage 21 via the opening. A latch bolt 3 is installed to the door 5 and includes an operation portion 31. The first shaft 41 extends through the operation portion 31 and is connected to the rotary part 11, so that when the first shaft 41 of the first lock 1 is rotated, the first shaft 41 rotates the operation portion 31 to lock or unlock the latch bolt 3.

In one embodiment, the first lock 1 is the new lock, for example, the old first lock is a mechanical lock, and the new first lock 1 is an electric lock. In this embodiment, the electric lock is installed to the inside of the door 5 and includes a knob 112 that is formed with the second shaft 111 of the rotary part 11. By rotating the knob 112, the latch bolt 3 and the first lock 4 are unlocked. The second shaft 111 of the rotary part 11 extends through the second lock 2, and the users can operate the knob 112 from the inside of the door 5. The second lock 1 in this embodiment is located at the inside of the door 5, and the first lock 4 is a mechanical lock, such as an assistant lock, is located at the outside of the door 5. The first lock 4 includes a lock cylinder 42 which is cooperated with the operation portion 31 of the latch bolt 3 so as to rotate the latch bolt 3.

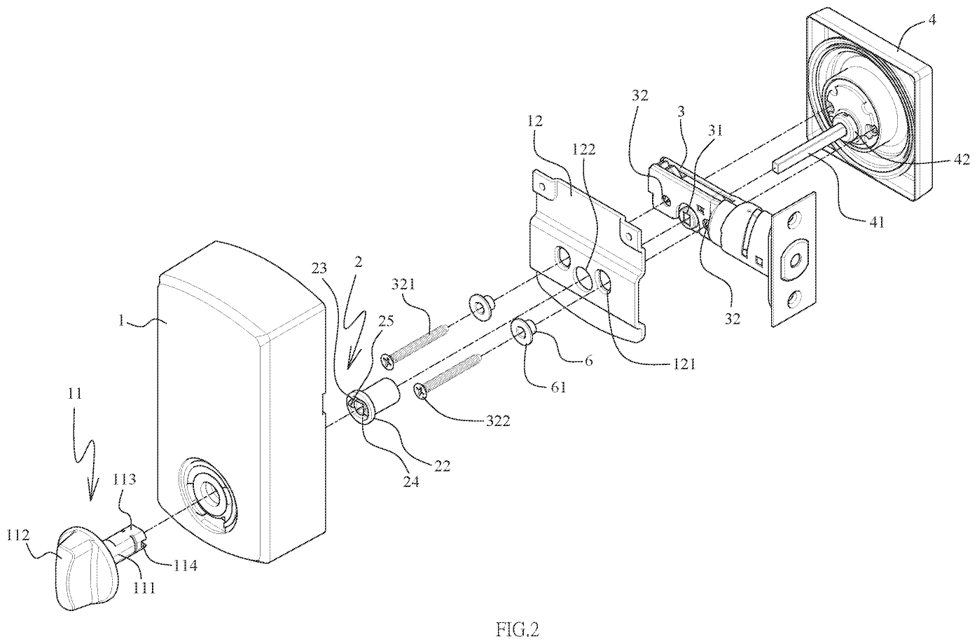

As shown in FIGS. 2 to 4, the sleeve 2 includes the passage 21 which forms the opening in the first end of the sleeve 2, and a first flange 22 extends radially from the second end of the sleeve 2. A recess 23 is defined in the second end of the sleeve 2 and is shaped to be engaged with the second shaft 111. In this embodiment, the recess 23 is concaved axially in the second end of the sleeve 2. The distal end of the second shaft 111 and the recess 23 are non-circular shaped so that the second shaft 111 is able to drive the sleeve 2. The second shaft 111 includes at least one first surface 113. At least one second surface 24 is formed to the inner periphery of the recess 23. When the second shaft 111 is engaged with the recess 23, the at least one first surface 113 and the at least one second surface 24 are engaged with each other to form a non-circle shape.

At least one protrusion 25 extends from the inner end of the recess 23. The second shaft 111 includes at least one notch 114 with which the at least one protrusion 25 is engaged, such that the second shaft 111 is securely engaged with the sleeve 2 to stably drive the sleeve 2. In another embodiment, the recess 23 can be omitted, the sleeve 2 includes at least one protrusion 25, and the second shaft 111 includes at least one notch 114 defined in the distal end thereof. By the engagement between the at least one protrusion 25 and the at least one notch 114 can achieve the expected purpose.

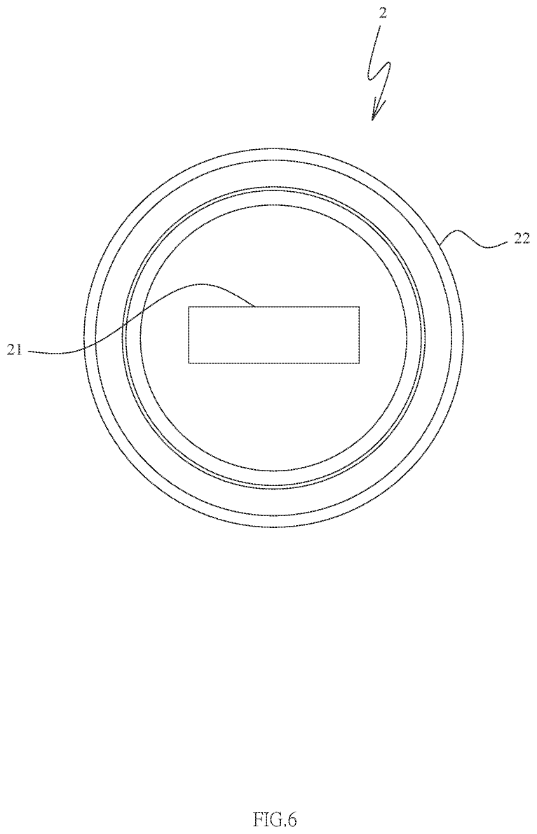

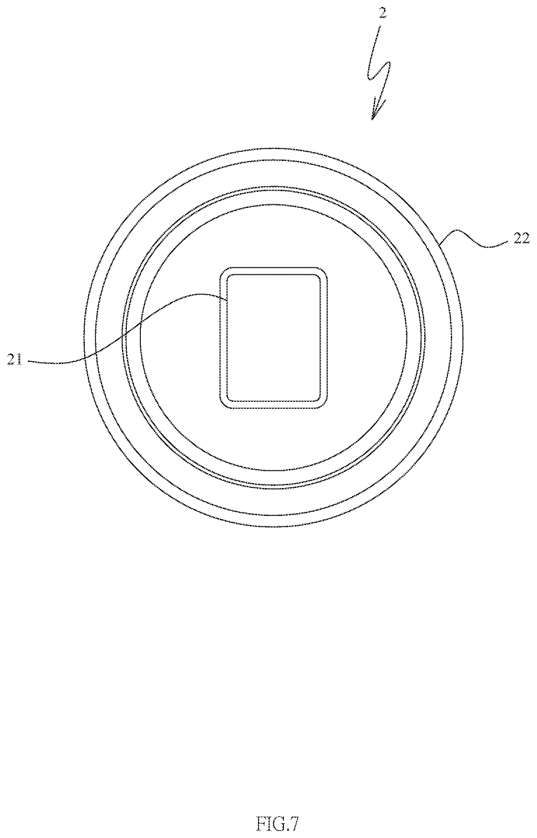

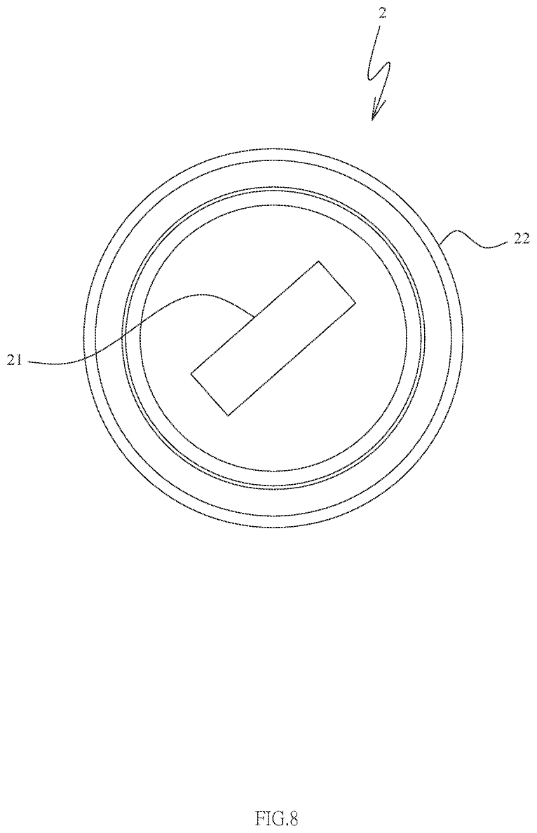

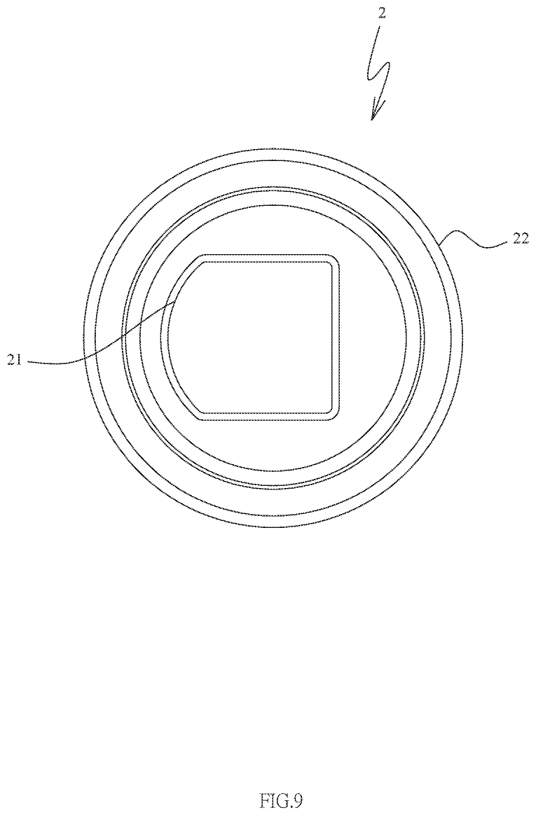

The passage 21 of the sleeve 2 is used to engage with the first shaft 41 which is an elongate part, so that the shape of the cross section of the first shaft 41 can be straight linear-shaped, rectangular-shaped, D-shaped, cross-shaped or polygonal-shaped. The corresponding shape of the opening that is formed by the passage 21 can be a straight linear-shaped opening, a rectangular-shaped opening, a D-shaped opening, a cross-shaped opening or a polygonal-shaped opening as shown in FIGS. 6 to 9. As shown in FIG. 8, the opening can also be tilt to be cooperated with the orientation of the first shaft 41.

The latch bolt 3 includes at least one fixing hole 32 so as to position the first and second locks 4 relative to the latch bolt 3. The second lock 1 includes a plate 12 that has at least one first bore 121 located corresponding to the at least one fixing hole 32. The latch bolt 3 is located between the plate 12 and the first lock 4, so as to adjust the position of the second lock 1. The plate 12 is also used to position the second lock 1 and the latch bolt 3. The plate 12 includes a second bore 122 that is located corresponding to the sleeve 2 and allows the first flange 22 to pass through. The inner diameter of the at least one first bore 121 is larger than the outer diameter of the at least one fasten element 321. At least one adaptor 6 is mounted to the at least one fasten element 321, the at least one fasten element 321 extends through the at least one first bore 121 and is fixed to the at least one fixing hole 32. The at least one adaptor 6 is made of resilient material and is engaged with the inner periphery of the at least one first bore 121. The at least one adaptor 6 includes a second flange 61 which extends radially from one end of the at least one adaptor 6, the second flange 61 faces the second lock 1. The outer diameter of the second flange 61 is larger than the inner diameter of the at least one first bore 121. The at least one fasten element 321 has a head 322 on one end thereof, and the head 322 contacts the second flange 61 of the at least one adaptor 6 to enhance stability of the at least one fasten element 321 relative to the plate 12. Because the inner diameter of the at least one first bore 121 is larger than the outer diameter of the at least one fasten element 321, so that different types of the at least one fasten element 321 can be easily used as long as the head of the at least one fasten element 321 contacts against the at least one adaptor 6. The at least one first bore 121 can be a circular bore, an elongate bore, an oval bore, a polygonal bore or any geometric shape bore. The second lock 1 therefore can be compatible to different types of the first lock 4 by the present invention so as to reduce expense and installation time.

While we have shown and described the embodiment in accordance with the present invention, it should be clear to those skilled in the art that further embodiments may be made without departing from the scope of the present invention.

What is claimed is:

1. An installation kit for an electric lock, comprising:
a first lock having a first shaft;
a second lock having a rotary part rotatably connected thereto, the rotary part including a second shaft;
a sleeve engaged with the rotary part and being driven by the rotary part, the sleeve including a passage which forms an opening, the opening being shaped to be matched with the shape of the cross section of the first shaft which extends through the passage via the opening, and
a latch bolt including an operation portion, the first shaft extending through the operation portion and connected to the rotary part so as to rotate the operation portion to lock or unlock the latch bolt.

2. The installation kit for an electric lock as claimed in claim 1, wherein the sleeve includes a first flange and a recess that is defined in one end of the sleeve, the second shaft is engaged with the recess.

3. The installation kit for an electric lock as claimed in claim 2, wherein the second shaft includes at least one first surface, at least one second surface is formed to an inner periphery of the recess, when the second shaft is engaged with the recess, the at least one first surface and the at least one second surface are engaged with each other to form a non-circle shape.

4. The installation kit for an electric lock as claimed in claim 2, wherein at least one protrusion extends from an inner end of the recess, the second shaft includes at least one notch with which the at least one protrusion is engaged.

5. The installation kit for an electric lock as claimed in claim 1, wherein the opening is a straight linear-shaped opening, a rectangular-shaped opening, a D-shaped opening, a cross-shaped opening or a polygonal-shaped opening.

6. The installation kit for an electric lock as claimed in claim 5, wherein the second lock is an electric lock.

7. The installation kit for an electric lock as claimed in claim 5, wherein the first lock is an assistant lock and includes a lock cylinder which is connected with the first shaft.

8. The installation kit for an electric lock as claimed in claim 1, wherein the latch bolt includes at least one fixing hole, the second lock includes at least one fasten element, a plate having at least one first bore that is located corresponding to the at least one fixing hole, the plate includes a second bore that is located corresponding to the sleeve, an inner diameter of the at least one first bore is larger than an outer diameter of the at least one fasten element, at least one adaptor is mounted to the at least one fasten element so that the at least one fasten element extends through the at least one first bore and is fixed to the at least one fixing hole.

9. The installation kit for an electric lock as claimed in claim 8, wherein the at least one adaptor is made of resilient material and is engaged with an inner periphery of the at least one first bore.

10. The installation kit for an electric lock as claimed in claim 8, wherein the at least one adaptor includes a second flange which faces the second lock, an outer diameter of the second flange is larger than an inner diameter of the at least one first bore.

11. The installation kit for an electric lock as claimed in claim 8, wherein the at least one first bore is a circular bore, an elongate bore, an oval bore, a polygonal bore or any geometric shape bore.

12. The installation kit for an electric lock as claimed in claim 1, wherein the second lock includes a plate, the plate includes a second bore located corresponding to the sleeve.

13. An installation kit for an electric lock, comprising:
a sleeve including a passage which forms an opening in a first end of the sleeve, a first flange extending radially from a second end of the sleeve, a recess defined in the second end of the sleeve, at least one second surface formed to an inner periphery of the recess, at least one protrusion extending from an inner end of the recess, the at least one second surface being a non-circle surface.

14. The installation kit for an electric lock as claimed in claim 13, wherein the electric lock includes a knob which has a second shaft formed thereto, the second shaft includes at least one first surfaced and at least one notch, the at least one first surfaced is a non-circle surface which is engaged with the at least one second surface, the at least one protrusion of the sleeve is engaged with the at least one notch of the second shaft.

15. The installation kit for an electric lock as claimed in claim 13, wherein the opening is a straight linear-shaped opening, a rectangular-shaped opening, a D-shaped opening, a cross-shaped opening or a polygonal-shaped opening.
